(19) United States
(12) Patent Application Publication
(10) Pub. No.: US 2017/0292548 A1
(43) Pub. Date: Oct. 12, 2017

(54) WALL BRACKET

(71) Applicant: Adam Hall GmbH, Neu-Anspach (DE)

(72) Inventor: Martin Bitterlich, Kelkheim (DE)

(73) Assignee: Adam Hall GmbH

(21) Appl. No.: 15/632,634

(22) Filed: Jun. 26, 2017

Related U.S. Application Data
(62) Division of application No. 15/147,978, filed on May 6, 2016.

(30) Foreign Application Priority Data
May 6, 2015 (DE) 202015003355.5

(51) Int. Cl. F16B 2/06; F16M 13/02

(52) U.S. Cl. CPC F16B 2/06; F16M 13/02; G10G 5/00

(57) ABSTRACT

A wall bracket for guitars is provided. The wall bracket includes a fixing housing and a plurality of holding arms. The holding arms are mounted in the fixing housing and are configured to pivot between a holding position and a release position. In particular, each holding arm includes in each case a holding region arranged on the exterior of the fixing housing and a bearing region arranged on the interior of the fixing housing. The holding arms have a predetermined tension to the release position via a spring arrangement.

### CROSS-REFERENCE TO RELATED APPLICATION

The present application is a divisional application of U.S. application Ser. No. 15/147,978 filed on May 6, 2016, which claims priority to German Application No. 202015003355.5 filed on May 6, 2015, which applications are incorporated herein by reference.

### TECHNICAL FIELD

The present invention relates to a wall bracket in accordance with the preamble of claim 1.

### BACKGROUND

Typically, a guitar wall bracket includes fixing housing that is attached to a wall and two holding arms are mounted on the fixing housing which protrudes in the manner of a fork having two prongs to form a support for a guitar head. In particular, at least one of the holding arms is movable towards the other holding arm. For example, the movable holding arm is mounted on the fixing housing with an end part of a bent lever portion that is rotated about its longitudinal axis extending in the direction towards the wall. Accordingly, the movable holding arm can be pivoted by a circular movement.

Although friction-increasing means are provided between the holding arms and the fixing housing to enable the holding arms remain in the assumed position, the holding arms tend, in particular due to the fact that the friction-increasing means are susceptible to wear, to slump in a downward direction in the assembled state merely by reason of their intrinsic weight. Namely, increases the difficulty to suspend an object, in particular a guitar, between the holding arms. Therefore, it is the object of the present invention to provide a wall bracket of to suspend an object in the wall bracket more easily. In particular, the wall bracket in accordance with the present invention is characterized by a simple handling capability which is substantially independent of wear because the spring arrangement makes it possible to hold the holding arms in the release state even over long periods of use.

The above information disclosed in this section is merely for enhancement of understanding of the background of the invention and therefore it may contain information that does not form the prior art that is already known in this country to a person of ordinary skill in the art.

### SUMMARY

The present invention provides a wall bracket for guitars that includes a fixing housing and two holding arms mounted in the fixing housing. For example, the wall bracket may provide holding arms that may improve the ease of suspending an object from the wall bracket.

In one aspect, the present invention includes a wall bracket for guitars that may include a fixing housing; and a plurality of holding arms mounted in the fixing housing and configured to pivot between a holding position and a release position. Each holding arm may include in each case a holding region disposed on an exterior of the fixing housing and a bearing region disposed on an interior of the fixing housing. The holding arms may be configured to have a predetermined tension to the release position via a spring arrangement.

In another exemplary embodiment of the present invention an identification structure for wall brackets and/or microphone stands and/or instrument stands may include a receiving groove and an identification ring that may be configured to be inserted into the receiving groove.

### BRIEF DESCRIPTION OF DRAWINGS

The above and other features of the present invention will now be described in detail with reference to exemplary embodiments thereof illustrated in the accompanying drawings which are given hereinbelow by way of illustration only, and thus are not limitative of the present invention, and wherein:

FIG. 1A is an exemplary perspective view of a wall bracket in accordance with an exemplary embodiment of the present invention;

FIG. 1B is an exemplary detailed view of the wall bracket shown in FIG. 1A in accordance with an exemplary embodiment of the present invention;

FIG. 1C is an exemplary coil spring for use in a wall bracket in accordance with an exemplary embodiment of the present invention according to FIGS. 1A and 1B;

FIG. 2 is an exemplary rear view of a fixing housing of the wall bracket in accordance with an exemplary embodiment of the present invention according to FIGS. 1A-1C;

FIG. 3 is an exemplary plan view of the wall bracket in accordance with an exemplary embodiment of the present invention according to FIGS. 1A-1C;

FIG. 4 is an exemplary perspective view of the wall bracket in accordance with an exemplary embodiment of the present invention;

FIG. 5 is an exemplary view corresponding to the perspective view of FIG. 1C of an exemplary embodiment of the spring arrangement; and

FIG. 6 is an exemplary a view corresponding to the rear view of FIG. 2 of an exemplary embodiment of the fixing housing comprising the spring arrangement of FIG. 5.

Reference numerals set forth in the Drawings includes reference to the following elements as further discussed below:

1—wall bracket

2—fixing housing

3, 4—holding arms

5, 6—holding regions

7, 8—bearing regions

7A, 8A—bearing region ends

9—spring arrangement

9A, 9B—coil springs

9C—connection web

9D, 9E—holding webs

10, 11—holding slots

12, 13—retaining rings

16—circumferential receiving groove

17, 19 end pins

18—identification ring

20—attachment point for a logo

21 guide slot

22 separation wall

It should be understood that the appended drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other exemplary embodiments, which may be included within the spirit and scope of the invention as defined by the appended claims.

However, the present invention is not limited to the exemplary embodiments set forth below, and may be embodied in various other forms. The present exemplary embodiments are for rendering the disclosure of the present invention complete and are set forth to provide a complete understanding of the scope of the invention to a person with ordinary skill in the technical field to which the present invention pertains, and the present invention will only be defined by the scope of the claims. In the description of the present invention, a detailed explanation of publicly known related technologies may be omitted so as to avoid unnecessarily obscuring the subject matter of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, in order to make the description of the present invention clear, unrelated parts are not shown and, the thicknesses of layers and regions are exaggerated for clarity. Further, when it is stated that a layer is “on” another layer or substrate, the layer may be directly on another layer or substrate or a third layer may be disposed therebetween.

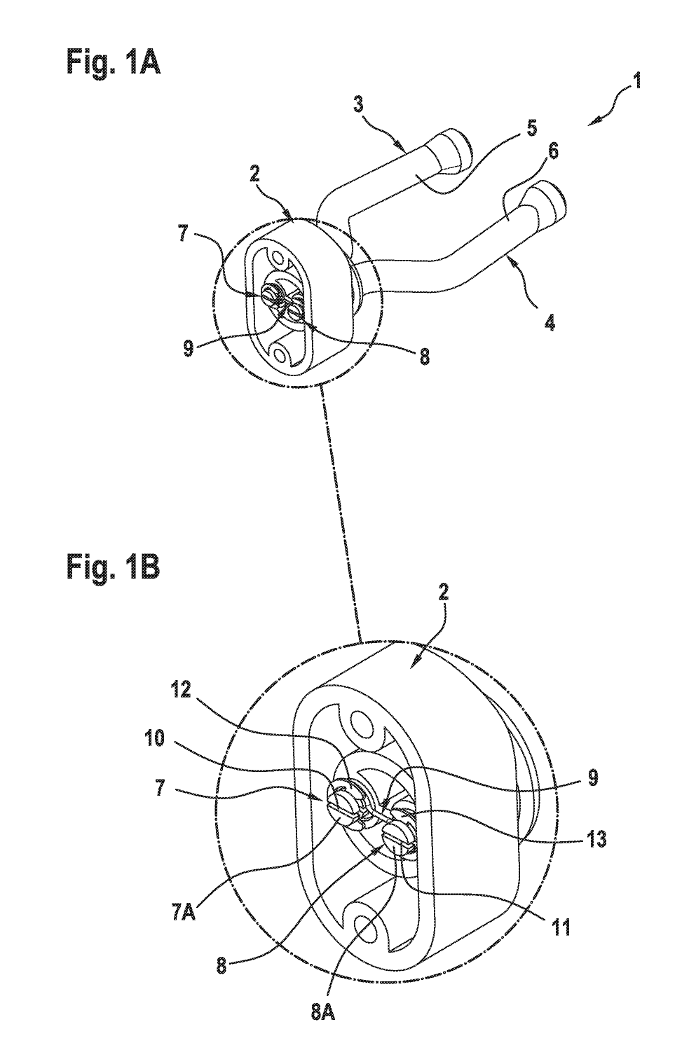

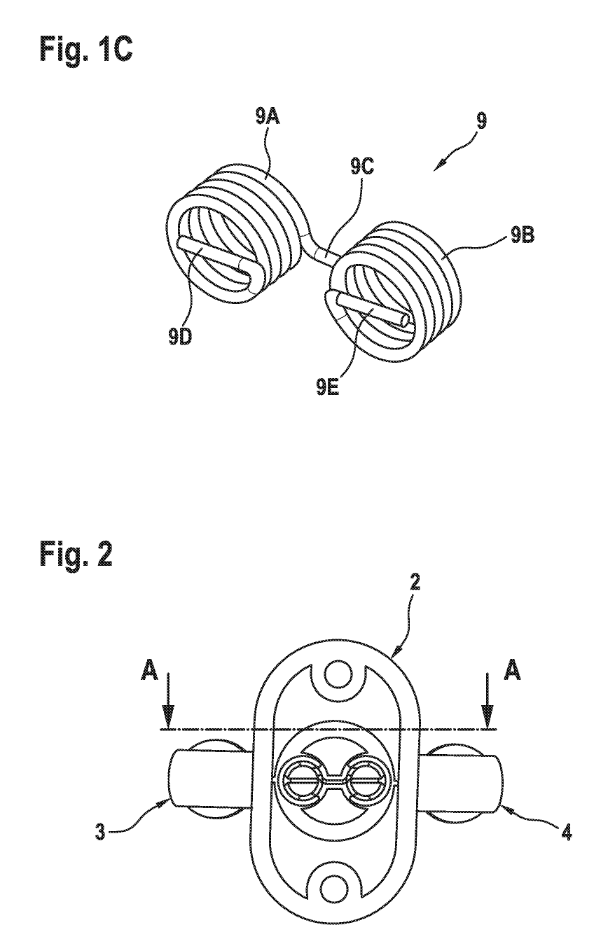

As shown in FIG. 1A, a wall bracket 1 in accordance with an exemplary embodiment of the present invention may include a fixing housing 2 and a plurality of holding arms 3, 4, in particular two holding arms 3, 4. The holding arms 3, 4 may each include a holding region 5, 6 and a bearing region 7, 8. Each holding arm 3, 4 may be coupled to the fixing housing 2 via its respective bearing region 7, 8.

The structure of the connection of the holding arms 3, 4 to the fixing housing 2 as shown in FIG. 1B which shows an exemplary detailed view of the fixing housing 2. The bearing regions 7, 8 of the holding arms 3, 4 may be configured to be inserted adjacent to one another in each case through a suitable bearing opening in the interior of the fixing housing 2. For example, the bearing regions 7, 8 may be mounted therein and may be configured to rotate about their respective longitudinal axis. The bearing regions 7, 8 may each include a bearing region end 7A, 8A that protrudes beyond the bearing openings. A spring arrangement 9 may be mounted on both bearing region ends 7A, 8A.

FIG. 1C shows, in detail, the spring arrangement 9, in the form of a coil spring arrangement that may include a plurality of coil springs 9A, 9B and a connection web 9C. The connection web 9C may couple the two coil springs 9A, 9B to one another perpendicularly to their respective longitudinal axes. Furthermore, the coil springs 9A and 9B may each include a holding web 9D and 9E, respectively.

As shown in FIG. 1B, the bearing region ends 7A, 8A may each include a holding slot 10, 11. The holding slot 10, 11 may be configured to receive in each case one of the holding webs 9D, 9E of the respective coil spring 9A, 9B. In particular, free rotation of the coil springs 9A, 9B about the respective bearing region ends 7A, 8A may be prevented. Instead a force may be transmitted from the spring arrangement 9 to the respective bearing region ends 7A, 8A. The holding arms 3, 4 may correspond to the tension of the spring arrangement 9.

As shown in FIG. 2, the holding webs 9D, 9E may couple the coil springs 9A, 9B to the bearing regions 7, 8 of the holding arms 3, 4. Accordingly, the tension of the coil springs 9A, 9B may be configured to be adjusted based on a rotational movement of at least one of the holding arms 3, 4 about the longitudinal axis of its respective bearing region 7, 8. Finally, as shown in FIG. 2, a retaining ring 12 and 13 may be mounted in each case on the respective bearing region end 7A and 7B respectively, to hold the spring arrangement 9 in a secure manner.

The release state may include the holding regions 5 and 6 of the two holding arms 3, 4, that protrude in the manner of a fork with two prongs from the fixing housing 2, spaced apart. In the release state, the spring arrangement 9 may be configured to have a minimal predetermined tension that may ensure that the holding arms 3, 4 are held securely in a release position. In the release state, an object, in particular a guitar or a similar instrument may be suspended between the two holding regions 5 and 6. When at least one of the holding regions 5, 6 with the object to be suspended are loaded the at least one associated holding arm 3, 4 may be configured to rotate about the longitudinal axis of its associated bearing region 7 or 8, wherein the holding regions 5, 6 may be configured to move closer towards one another.

For example, the holding regions may be configured to move closer towards one another until they clamp the object to be suspended. This state is defined hereinafter as the holding state. In the holding state, the spring arrangement may have a predetermined tension with a greater value then the predetermined tension of the release state. Accordingly, when the suspended object is lifted and the load is thus removed from the holding regions 5, 6 the holding arms 3, 4 may be configured to rotate back to the release position by the force of the tensioned spring arrangement 9 that may act upon the bearing regions 7, 8. In particular, during suspension, the holding arms 3, 4 may be configured to move by the weight of the object to be suspended and, during removal, may be configured to move to the respectively desired position by the force of the spring arrangement with a greater predetermined tension. For example, it is not necessary to manually move the holding arms 3, 4, which considerably simplifies handling of the wall bracket in accordance with an exemplary embodiment of the present invention.

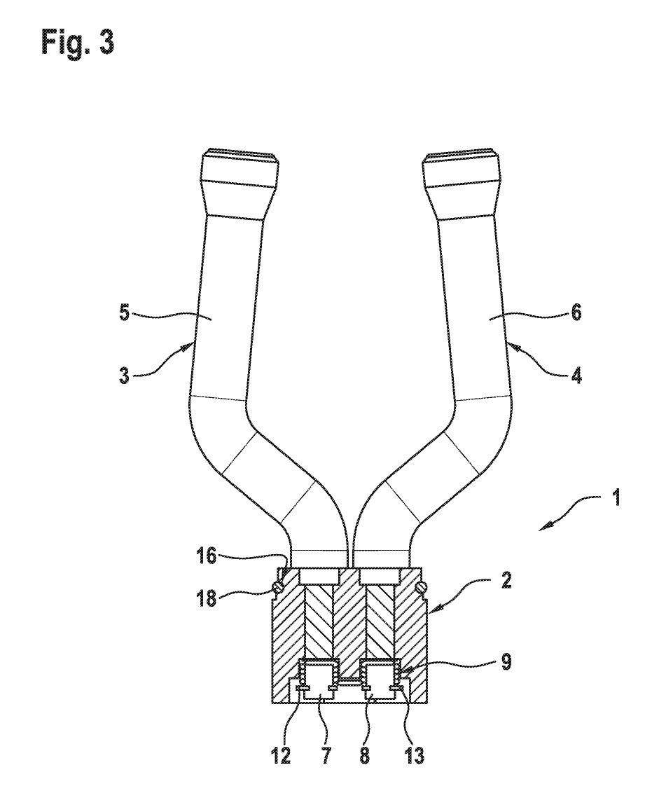

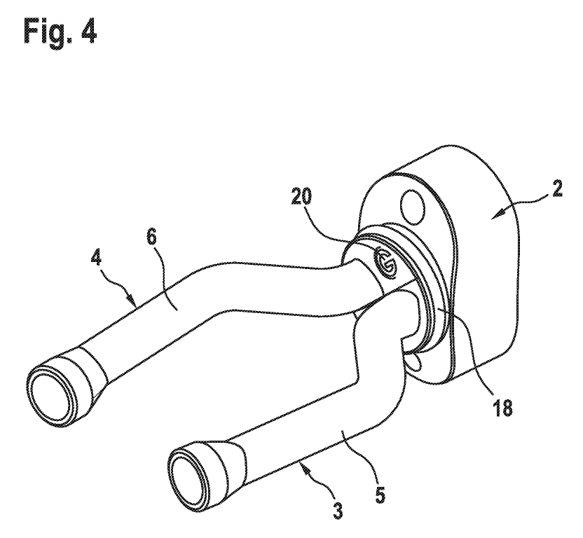

As shown FIG. 3, the fixing housing 2 may include a circumferential receiving groove 16, in which an identification ring 18 may be arranged. FIG. 4 shows an exemplary perspective view of the wall bracket 1. As shown FIG. 4, the fixing housing may include an identification ring 18 arranged in a circumferential receiving groove. Furthermore, the fixing housing 2 may include an attachment point 20 for a logo.

Accordingly, the present invention also relates to an identification structure which is suitable for wall brackets, in particular instrument wall brackets, microphone stands and/or instrument stands. The identification structure may include a receiving groove that may be mounted at a suitable location on the wall bracket, as previously described with reference to the receiving groove 16, or on the microphone stand or the instrument stand. An identification ring may be disposed within the receiving groove and may be fitted in the receiving groove and may be visible in the inserted state. As previously described, in this case the receiving groove may be disposed in a fixing housing 2 of the wall bracket 1 or in a region of a microphone stand that may be adjacent to a microphone holder. Accordingly, the receiving groove may be provided at a suitable location on the instrument stand, to enable the identification ring to be easily visible during use of the wall bracket, the microphone stand or the instrument stand. The identification ring may be interchangeable.

In order to be able to distinguish different wall brackets, microphone stands and/or instrument stands from one another, (e.g. with respect to the type of objects, microphones or instruments to be held), the identification ring may be provided in a different color. For example, the different colors may enable differentiation between a plurality of instrument stands, which are arranged on a stage, with regard to the musicians by allocating a color to each musician.

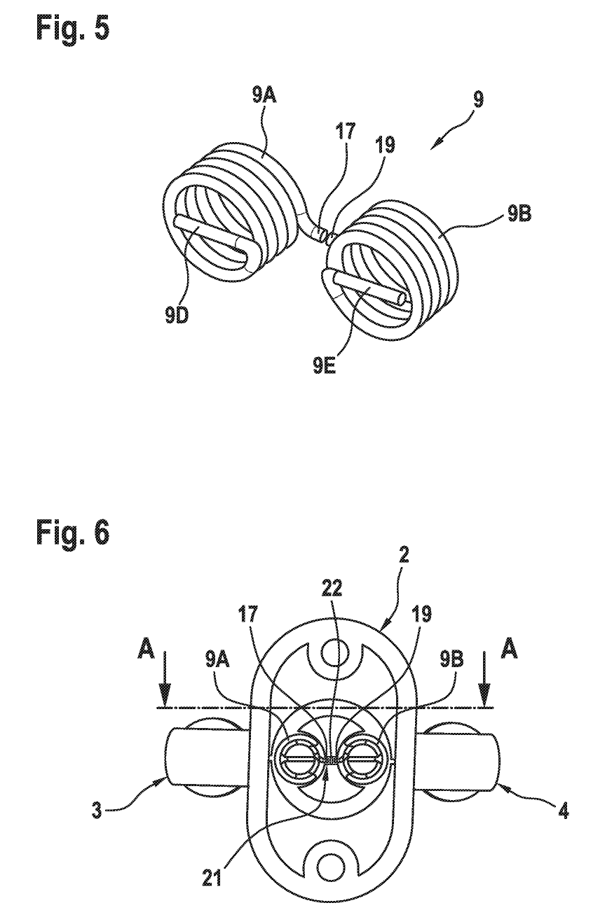

FIGS. 5 and 6 show an exemplary embodiment of the wall bracket according to the present invention. The exemplary embodiment of FIGS. 5 and 6 illustrates the spring arrangement 9 that may include a plurality (e.g., two) coil springs 9A and 9B that are not connected to each other via a connection web, as connection web 9C of FIG. 1C, rather than being separated into two separate coil springs 9A and 9B ending in an end pin 17 and 19, respectively. All other components of the spring arrangement 9 are identical to the embodiment of FIG. 1C. The spring arrangements of FIGS. 5 and 6 are shown in the installed state.

The difference of the exemplary embodiment of FIG. 6 to the exemplary embodiment of FIG. 2 is that the fixing housing 2 may include a pin guide slot 21 into which the end pins 17 and 19 are inserted and the end pins 17 and 19 may be configured to be guided in slot 21. The guide slot 21 may include a middle separating wall 22. The end pins 17 and 19 of the coil springs 9A and 9B may be configured to engage or may end shortly before said wall 22. All other components of the wall bracket 1 that have been described before with reference to FIGS. 1 to 4 are the same both in structure and function so that reference can be made with respect to these features to the fore-going description. In addition to the above written disclosure of the invention and in order to supplement same, reference is hereby explicitly made to the FIGS. of the drawing.

In summary, a wall bracket 1 may include a fixing housing 2 and a plurality of holding arms 3, 4. The plurality of holding arms may be mounted in the fixing housing 2 and may be configured to pivot between a holding position and a release position. Each holding arm 3, 4 may include in each case a holding region 5, 6 arranged on the exterior of the fixing housing 2, and a bearing region 7, 8 arranged on the interior of the fixing housing 2. The wall bracket 1 in accordance with an exemplary embodiment of the present may include holding arms 3, 4 that may be configured to have a predetermined tension to the release position via a spring arrangement 9.

The invention has been described in detail with reference to exemplary embodiments thereof. However, it will be appreciated by those skilled in the art that changes may be made in these exemplary embodiments without departing from the principles and spirit of the invention, the scope of which is defined in the appended claims and their equivalents.

1. A wall bracket for guitars, comprising:
a fixing housing; and
a plurality of holding arms mounted in the fixing housing and configured to pivot between a holding position and a release position,
wherein each holding arm includes a holding region disposed on an exterior of the fixing housing and a bearing region disposed on an interior of the fixing housing,
wherein the holding arms are configured to a predetermined tension to the release position via a spring arrangement.

2. The wall bracket of claim 1, wherein the bearing regions include a bearing region end.

3. The wall bracket of claim 2, wherein the spring arrangement is configured to act upon the bearing region ends.

4. The wall bracket of claim 1, wherein the spring arrangement is a leaf spring arrangement.

5. The wall bracket of claim 1, wherein the spring arrangement is a coil spring arrangement.

6. The wall bracket of claim 5, wherein the coil spring arrangement includes a plurality of coil springs.

7. The wall bracket of claim 6, wherein the plurality of coil springs are connected to one another via a connection web.

8. The wall bracket of claim 6, wherein the plurality of coil springs each include a holding web and the bearing region ends each include a holding slot configured to engage the holding webs.

9. The wall bracket of claim 2, wherein a retaining ring is disposed on the bearing region ends.

10. The wall bracket of claim 2, wherein the fixing housing includes a receiving groove configured to receive an identification ring.

11. The wall bracket of claim 2, wherein the identification ring is green in accordance with the color pantone 375C.

12. The wall bracket of claim 1, wherein the coil springs are separate members having end pins configured to be guided in a guide slot of the fixing housing in the assembled state of the spring arrangement.
